(19) United States
(12) Patent Application Publication
(10) Pub. No.: US 2025/0086091 A1
(43) Pub. Date: Mar. 13, 2025

(54) SYSTEMS AND METHODS FOR LAB GENERATION, TEST MANAGEMENT AND DEVICE MONITORING

(71) Applicant: LabScale Technologies, Inc., Milpitas, CA (US)

(72) Inventors: David Tse, San Jose, CA (US); Scott Vail, Santa Cruz, CA (US); Huacong Cai, Santa Clara, CA (US); Raika Qawam, Livermore, CA (US); Craig Griffin, San Jose, CA (US)

(73) Assignee: LabScale Technologies, Inc., Milpitas, CA (US)

(21) Appl. No.: 18/829,975

(22) Filed: Sep. 10, 2024

Related U.S. Application Data
(60) Provisional application No. 63/537,664, filed on Sep. 11, 2023.

(51) Int. Cl. G06F 11/34; G06F 11/36

(52) U.S. Cl. CPC G06F 11/3466; G06F 11/3688

(57) ABSTRACT

A test automation system for efficiently testing a wide range of devices, including embedded devices, IoT devices, mobile devices, and edge AI devices, is disclosed. The system employs a unique architecture and technical solutions to overcome limitations of existing testing platforms. It provides a comprehensive and flexible testing solution by incorporating modular components. The system includes a device integration package (DIP) that enables the system to communicate with and test any type of device. The system enables efficient management of diverse device types, streamlined test case creation and execution, and intelligent analysis of test results. Through its innovative design, the test automation system addresses the technical challenges associated with testing heterogeneous devices, enhancing the efficiency and effectiveness of the testing process. The system's adaptability and scalability make it suitable for testing a wide range of devices in various industries, including telecommunications, automotive, and consumer electronics.

### CROSS-REFERENCE TO RELATED APPLICATIONS

This application claims the benefit of U.S. Provisional Application 63/537,664, filed Sep. 11, 2023, titled “SYSTEM AND METHOD FOR LAB GENERATION, TEST MANAGEMENT AND DEVICE MONITORING,” which is herein incorporated by reference in its entirety.

### BACKGROUND

### Field of the Art

This invention is generally related to the field of device testing.

### Discussion of the State of the Art

Testing devices such as embedded devices, IoT devices, mobile devices and edge AI devices presents several technical challenges. These devices often have unique interfaces and communication protocols that make it difficult to develop a universal testing system. Existing test automation solutions are often limited to specific platforms or require extensive customization to work with new or different types of devices. This lack of flexibility creates a technical barrier to comprehensive testing.

Another technical challenge is coordinating testing across multiple devices efficiently. Devices under test may be located in different labs or facilities and connected via different networks. Existing solutions struggle to manage and orchestrate testing across distributed environments. Scheduling and running tests on multiple devices in parallel is complex and requires significant manual effort with current systems.

Additionally, current testing solutions do not adequately address the challenge of collecting and analyzing test results and performance metrics from multiple devices. Aggregating data from distributed testing environments and generating meaningful reports and insights is technically difficult, especially when dealing with large volumes of data. Existing reporting capabilities are often rudimentary and do not provide the level of detail and analysis needed for effective decision making.

Interoperability between test automation systems and lab management systems is another technical hurdle. Most test automation solutions do not integrate with the systems used to manage the lab environment, devices and infrastructure. This lack of integration makes it challenging to have a comprehensive, end-to-end testing solution. Lab management and device orchestration are often handled manually or with entirely separate systems, leading to inefficiencies and compatibility issues.

There is a need for an improved test automation system that addresses these technical challenges. The system should have a flexible architecture to support a wide variety of devices without extensive customization. It should enable efficient scheduling, coordination and execution of tests across multiple devices in distributed environments. The system should provide robust data collection and analysis capabilities to generate meaningful insights from test results across devices. Finally, it should integrate with lab management systems to orchestrate the entire testing process from end to end. Overcoming these technical hurdles requires innovative solutions that go beyond existing approaches.

### SUMMARY

The present disclosure describes a test automation system that addresses the technical challenges of testing a wide variety of devices, including embedded devices, IoT devices, mobile devices, and edge AI devices. The system employs a unique architecture and several technical solutions to overcome the limitations of existing testing platforms and provide an efficient, flexible, and comprehensive testing solution.

The system includes a device integration package (DIP) that enables the system to communicate with and test any type of device. The DIP includes a specification for a set of APIs and a configuration specification that define the technical interface between the system and a particular type of device. This technical solution allows the system to abstract away the differences between devices and provide a uniform way of interacting with them, regardless of their underlying hardware or software platforms. The DIP approach improves upon existing solutions, which often require custom code or extensive configuration to support new devices.

Another technical component of the system is a lightweight software agent that runs on the devices under test or on a host connected to the devices. The agent is responsible for executing test jobs, monitoring device status, and collecting test results and performance metrics. The agent communicates with the system's backend using the APIs defined in the DIP, providing a seamless and efficient way to manage the testing process across multiple devices. The agent is designed to be cross-platform and can run on a variety of operating systems, including, but not limited to Linux, Android, and macOS, which allows the system to support a diverse range of devices and environments.

The system also includes a job scheduling and device pooling techniques that enables efficient coordination and execution of tests across multiple devices. The job scheduler employs algorithms to distribute test jobs across available devices and manage the execution of those jobs in a way that optimizes resource utilization and testing time. The device pooling techniques allows devices to be grouped together based on technical criteria such as hardware capabilities or software configurations, enabling targeted testing and efficient use of resources.

In addition to its testing capabilities, the system provides integrated lab management and device orchestration features that automate many of the technical tasks involved in managing a testing environment. The system can automatically discover and configure devices, monitor their status and availability, and control lab equipment such as power supplies and network switches. These technical solutions streamline the testing process and reduce the need for manual intervention.

The system also includes reporting and analytics capabilities that provide technical insights into device performance and behavior. The system employs data processing and aggregation techniques to collect and analyze test results and performance metrics from multiple devices in real-time. This technical solution enables the system to generate reports and visualizations that can help identify performance bottlenecks, detect anomalies, and optimize device configurations.

These technical solutions—the device-agnostic architecture, cross-platform agent, job scheduling and device pooling, integrated lab management, and reporting and analytics—represent an improvement over existing testing solutions. The system's approach enables it to overcome the technical limitations of existing platforms and provide an efficient, flexible, and comprehensive testing solution that can meet the evolving needs of the industry.

In summary, the present disclosure describes a test automation system that employs a combination of technical solutions to address the challenges of testing diverse devices in complex environments. The system's architecture, algorithms, and automated management capabilities provide a powerful and flexible solution that improves upon existing approaches and enables more efficient and effective testing of a wide range of devices, including edge AI devices.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a system for lab generation, test management and device monitoring in accordance with an exemplary embodiment of the invention.

FIG. 2 illustrates a test management system in accordance with an exemplary embodiment of the present invention.

FIG. 3 illustrates an exemplary process for configuring a test lab and managing testing and results according to one embodiment of the invention.

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a computing device that supports an embodiment of the inventive disclosure.

FIG. 7 illustrates components of a computing device that supports an embodiment of the inventive disclosure.

### DETAILED DESCRIPTION

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

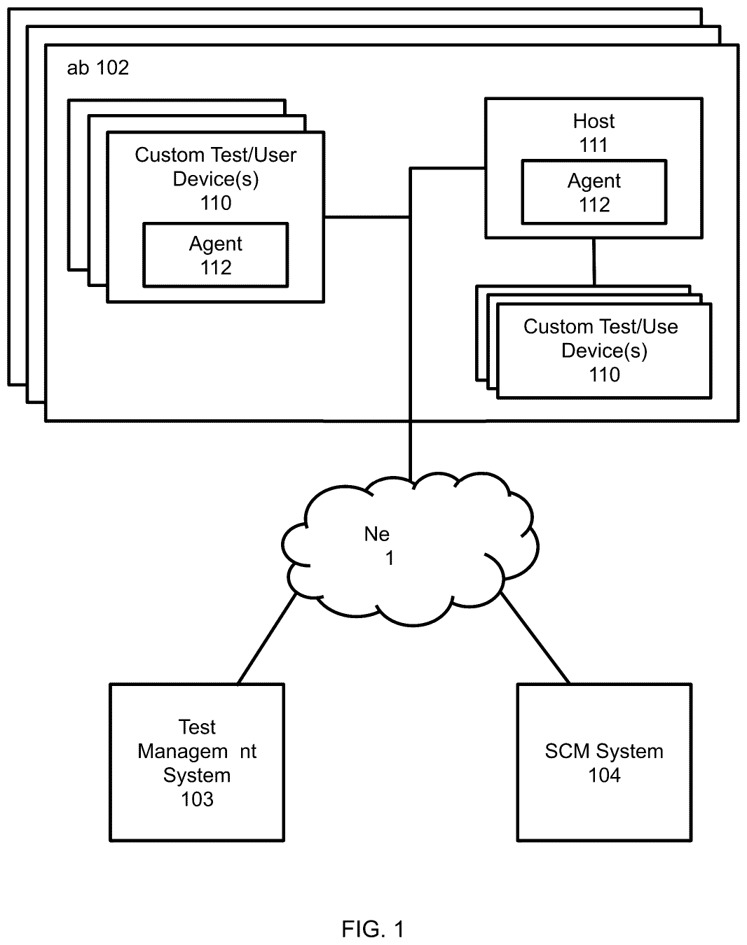

FIG. 1 illustrates an exemplary embodiment of a system for lab generation, test management and device monitoring in accordance with an exemplary embodiment of the invention. The system includes virtual testing lab 102 (which may be comprised of custom test/user device(s) 110, agent 112, and host machine 111), software configuration management (SCM) system 104, test management system 103, and a network 150 over which the various systems communicate and interact. The various components described herein are exemplary and for illustration purposes only and any combination or subcombination of the various components may be used as would be apparent to one of ordinary skill in the art. The system may be reorganized or consolidated, as understood by a person of ordinary skill in the art, to perform the same tasks on one or more other servers or computing devices without departing from the scope of the invention.

In one embodiment, the test management system 103 is a component of the test automation system that generates and manages virtual device testing labs 102. The test management system 103 receives input related to custom test devices 110, which may be tested individually and/or through a host 111. This input may include at least one of device specifications, configuration settings, and test parameters.

Based on the received input, the test management system 103 creates virtual device testing labs 102. These labs provide isolated environments for testing the custom test devices 110 without interfering with other devices or systems. The test management system 103 may configure the virtual labs with the necessary software, firmware, and/or hardware emulations to closely mimic the characteristics of the physical test devices.

Once the virtual labs are set up, the test management system 103 generates test information, which may include test scripts, input data, and expected output values. This test information is then provided to the virtual labs for execution on the custom test devices 110. The test management system 103 may coordinate the execution of tests across multiple virtual labs, ensuring that tests are run efficiently and without conflicts.

After the tests are completed, the test management system 103 collects the test results from the virtual labs. These results may include data on the performance, functionality, and reliability of the custom test devices 110. The test management system 103 may store these results for later analysis or immediately process them to generate reports and insights.

Alternatively, the test management system 103 may use physical testing environments instead of virtual labs. In this case, the test management system 103 would coordinate the allocation of physical resources, such as test benches and measurement equipment, to perform the tests on the custom test devices 110.

Another alternative approach is for the test management system 103 to use a combination of virtual and physical testing environments. This hybrid approach allows for the benefits of virtual labs, such as scalability and flexibility, while also leveraging the realism and accuracy of physical testing for critical or complex test cases.

The test management system 103 may also employ different methods for generating test information. For example, it may use machine learning algorithms to automatically generate test cases based on historical data and device specifications. Alternatively, it may rely on manual input from test engineers to create custom test scripts tailored to the specific requirements of the custom test devices 110.

In one embodiment, lab 102 may comprise at least one custom test/user device 110 which may optionally be connected to test management system 103 through a host machine 111. This setup allows for the testing of various devices within a controlled environment, with the host machine 111 serving as the intermediary between the custom device(s) 110 and the test management system 103.

Agent 112 may be installed on at least one of custom test/user device(s) 110 and host machine 111. The role of Agent 112 is to establish communication between the custom device(s) 110 and the test management system 103. This communication is vital for the transmission of test data and results between the devices and the management system.

Within a given lab 102, custom device(s) 110 may be grouped or pooled for testing purposes through appropriate registration within the test management system 103. This grouping or pooling allows for efficient allocation of testing resources and can be based on various criteria such as device type, capabilities, or specific testing requirements. The registration process involves the identification and categorization of devices within the system, enabling the system to assign appropriate tests to each device or group of devices.

The operation of the system begins with the installation of agent 112 on the custom test/user device(s) 110 and/or host machine 111. Once installed, agent 112 establishes communication with the test management system 103. The custom device(s) 110 are then registered within the system and grouped or pooled based on the defined criteria. The test management system 103 can then assign and execute tests on the custom device(s) 110, with the results being communicated back to the system via Agent 112.

In an alternative embodiment, the system could include multiple host machines 111, each connected to a subset of the custom test/user device(s) 110. This configuration could provide increased testing capacity and allow for parallel testing of multiple devices. In another alternative, the system could include multiple test management systems 103, each responsible for a different set of devices or tests. This could allow for more specialized testing and improved scalability of the system.

In one embodiment, the software configuration management (SCM) system 104 is an integral component of the test automation system, responsible for managing and tracking build information and test information associated with the development of custom devices 110. The SCM system 104 serves as a centralized repository that stores and maintains data related to software builds and their corresponding test results.

At a high level, the SCM system 104 performs two primary functions. Firstly, it stores and manages build information, which includes details about the software versions, configurations, and dependencies of the custom devices 110. Secondly, it maintains test information, such as test cases, test results, and performance metrics associated with each build of the custom devices.

The SCM system 104 works by capturing and storing build information whenever a new version of the software for a custom device 110 is created. This information may include the source code version, compiler settings, libraries used, and any other relevant configuration details. Additionally, the SCM system 104 keeps track of the test information generated during the testing process of each build. This includes the test cases executed, the outcomes of those tests, and any performance measurements or logs collected during testing.

One key feature of the SCM system 104 is its ability to provide updates to the build information, such as notifying the test automation system about a new build event. When a new build of a custom device 110 becomes available, the SCM system 104 sends an update to the test management system 103, triggering the initiation of testing activities associated with that new build. This ensures that the latest version of the software is promptly tested and validated.

Alternatively, the SCM system 104 can be implemented using various approaches. One alternative is to integrate the SCM system 104 with existing version control systems, such as Git or Subversion, to leverage their capabilities for managing source code and build artifacts. Another alternative is to use a dedicated build management tool, such as Jenkins or TeamCity, which can automate the build process and provide build-related information to the SCM system 104. Additionally, the SCM system 104 can be implemented as a standalone application or as a module within a larger application lifecycle management (ALM) platform, depending on the specific requirements and existing infrastructure of the organization.

User device(s) 110 include, generally, a computer or computing device including functionality for communicating (e.g., remotely) over a network 150. Data may be collected from user devices 110, and data requests may be initiated from each user device 110. User device(s) 110 may be a server, a desktop computer, a laptop computer, personal digital assistant (PDA), an in- or out-of-car navigation system, a smart phone or other cellular or mobile phone, or mobile gaming device, among other suitable computing devices. User devices 110 may execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device 110 may be an electronic device including hardware, software, or embedded logic components or a combination of two or more such components and capable of carrying out the appropriate functions implemented or supported by the user device 110. For example and without limitation, a user device 110 may be a desktop computer system, a notebook computer system, a netbook computer system, a handheld electronic device, or a mobile telephone. The present disclosure contemplates any user device 110. A user device 110 may enable a network user at the user device 110 to access network 150. A user device 110 may enable its user to communicate with other users at other user devices 110.

A user device 110 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 110 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 110 one or more Hyper Text Markup Language (HTML) files responsive to the HTTP request. The user device 110 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 110 may also include an application that is loaded onto the user device 110. The application obtains data from the network 150 and displays it to the user within the application interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to client/user devices or other devices in response to HTTP or other requests from client devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiments, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

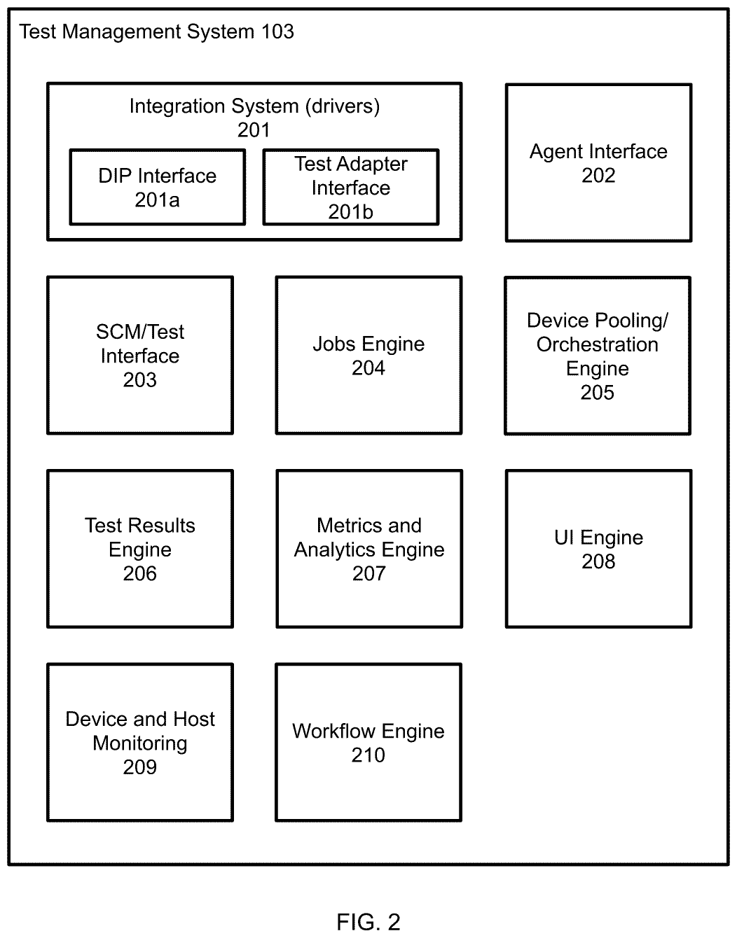

FIG. 2 illustrates an exemplary embodiment of the test management system 103. The test management system 103 includes integration system 201 (which may be comprised of DIP interface 201a and Test Adapter interface 201b), agent interface 202, SCM/test interface 203, jobs engine 204, device pooling/orchestration engine 205, test results engine 206, metrics and analytics engine 207, device and host monitoring engine 209, and workflow engine 210. The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

In one embodiment, the integration system 201 is designed to facilitate the integration of custom devices into the test management system for comprehensive testing. The integration system 201 serves as a bridge between the custom devices and the test management system, enabling seamless communication and interaction.

The integration system 201 provides two main components to support the integration process: a device integration package (DIP) and test adapters. The DIP is accessible through the DIP interface 201a, while the test adapters are available via the test adapter interface 201b. These components offer custom device developers the necessary resources and information to create device drivers and test adapters specific to their devices.

The device integration package (DIP) comprises at least one of tools, libraries, and documentation that assist developers in creating device drivers. These device drivers enable communication between the custom devices and the test management system 103. The DIP provides guidelines and best practices for implementing device drivers, ensuring compatibility and optimal performance within the testing environment.

Test adapters are software components that translate test commands and data between the test management system 103 and the custom devices. The test adapters ensure that the tests designed in the test management system can be executed on the custom devices seamlessly. The integration system 201 provides a framework and APIs for developing test adapters, allowing developers to map test commands to device-specific actions and interpret device responses accurately.

Alternatively, the integration system 201 may offer pre-built device drivers and test adapters for commonly used protocols and device types. These pre-built components can be leveraged by developers to accelerate the integration process, reducing the effort required to create custom drivers and adapters from scratch. The integration system 201 may also provide a plugin architecture, enabling developers to extend the functionality of existing drivers and adapters or create new ones as needed.

In one embodiment, Integration system 201 is operable to integrate custom devices to be tested with the test management system. This subsystem serves as a bridge, facilitating the connection between the custom devices and the test management system, ensuring that they can interact effectively for the purpose of conducting tests.

Integration system 201 provides at least one of device integration package (DIP) via DIP interface 201a and test adapters via test adapter interface 201b. The DIP and test adapters are tools that custom device developers can use to generate device drivers and test adapters, respectively. These drivers and adapters enable communication and integration between the custom device and the tests and the test management system 103.

The operation of the integration system 201 begins with the provision of a DIP or test adapter to the custom device developers. The developers then use this information to generate device drivers and test adapters that are compatible with the custom device and the test management system 103. Once these drivers and adapters are created, they are installed on the custom device, enabling it to communicate with the test management system 103 and participate in tests.

In an alternative embodiment, the integration system 201 could provide a software development kit (SDK) in addition to or instead of the DIP and/or test adapters. The SDK could include at least one of libraries, tools, and documentation that assist developers in creating device drivers and/or test adapters. In another alternative, the integration system 201 could include a device emulator that allows developers to test the drivers and/or adapters in a simulated environment before deploying them on the actual custom device. This could help to identify and resolve any issues or incompatibilities before the device is integrated with the test management system 103.

In one embodiment, agent interface 202 is generally operable to perform message handling between the test management system and at least one agent installed on custom test devices and/or host machines. This subsystem functions as a communication channel, facilitating the exchange of information, specifically tests and test results, between the test management system and the custom test devices and/or host machines.

Agent interface 202 may comprise a message broker or message handler. These components are responsible for managing the flow of messages between the test management system and the agent. This includes tasks such as routing messages to the correct destination, ensuring message delivery, and handling any errors or issues that may arise during message transmission.

The operation of agent interface 202 involves receiving tests from the test management system 103 and communicating these tests to the agent installed on the custom test devices and/or host machines. Once the tests are completed, the agent sends the test results back to the test management system via the agent interface 202. The message broker or message handler within the agent interface 202 ensures that these messages are correctly routed and delivered.

In an alternative embodiment, the agent interface 202 could include additional components such as a message queue for storing messages temporarily in case of network congestion or downtime. In another alternative, the agent interface 202 could use different communication protocols depending on the requirements of the test management system or the custom test devices. This could include protocols such as HTTP, MQTT, or CoAP, each offering different advantages in terms of speed, reliability, or resource usage.

In one embodiment, the SCM/test interface 203 is a subsystem within the test automation system that facilitates the exchange of build and test information between the system and external entities. Its primary function is to obtain build and test information associated with new builds and tests to be performed for a custom device.

At a high level, the SCM/test interface 203 acts as a communication bridge, enabling the test automation system to receive relevant data from various sources. It establishes connections with external systems, such as software configuration management (SCM) systems and other user systems, to gather the necessary build and test information.

The SCM/test interface 203 works by implementing a set of protocols and/or APIs that allow it to interact with different systems seamlessly. When a new build of a custom device becomes available, the SCM/test interface 203 communicates with the SCM system to retrieve the associated build information. This information may include details such as the software version, configuration settings, and dependencies. Similarly, when new tests need to be performed, the SCM/test interface 203 obtains the relevant test information from the designated user systems. This test information may include test cases, test data, and any specific requirements or constraints.

The SCM/test interface 203 employs various techniques or mechanisms to ensure reliable and efficient data transfer. It may utilize standard communication protocols, such as HTTP, REST, or SOAP, to establish connections with external systems. Additionally, it may implement error handling and retry techniques or mechanisms to handle potential network disruptions or system failures gracefully.

Alternatively, the SCM/test interface 203 can be designed to support different integration approaches. One alternative is to use a message-based architecture, where the SCM/test interface 203 subscribes to relevant topics or queues to receive build and test information asynchronously. Another alternative is to employ a plugin-based architecture, allowing the SCM/test interface 203 to support multiple SCM systems and user systems through customizable plugins. This approach enables flexibility and extensibility, as new systems can be integrated by developing corresponding plugins without modifying the core interface.

In one embodiment, jobs engine 204 is designed to manage jobs associated with custom device testing. This subsystem may comprise a job scheduler and job output storage, functioning to coordinate and manage one or more tests to be performed on one or more custom devices. Jobs engine 204 operates by managing criteria or triggers that initiate job execution, effectively overseeing a jobs queue for custom test devices and the tests to be performed.

The job scheduler component of jobs engine 204 is responsible for allocating and scheduling tests. Job scheduler may allocate and schedule tests based on predefined criteria, such as device availability, priority of tests, and specific requirements of each test job. This scheduling ensures that tests are performed efficiently and systematically across the available devices. The job output storage is where the results of these tests are stored. This storage allows for easy access to test outcomes, facilitating analysis and review of device performance.

Jobs engine 204 works by first identifying the tests that need to be performed and the devices available for testing. Based on the criteria or triggers set for job execution, such as a specific time, event, or condition, the job scheduler activates and assigns tests to the appropriate devices. As tests are completed, the results are collected and stored in the job output storage, where they can be accessed for further analysis.

Alternatives to this subsystem could include distributed job management, where job scheduling and output storage are handled by multiple, interconnected systems rather than a single centralized system. This could enhance scalability and fault tolerance. Another alternative could involve cloud-based job management, where tests and results are managed through cloud services, offering flexibility in terms of access and resources. Additionally, machine learning algorithms could be employed to optimize test scheduling and resource allocation, dynamically adjusting to the changing conditions and requirements of the testing environment.

In one embodiment, the device pooling/orchestration engine 205 is a subsystem within the test automation system that manages groups of devices for efficient and organized testing. Its primary function is to facilitate the grouping of devices based on user input and to orchestrate the execution of tests on these device groups.

At a high level, the device pooling/orchestration engine 205 allows users to define and manage logical groupings of devices. It provides an interface for users to specify which devices should be included in each group. These groupings can be based on various criteria, such as device characteristics (e.g., device type, operating system, hardware specifications) or the specific tests to be performed on the devices.

The device pooling/orchestration engine 205 works by maintaining a database and/or registry of available devices and their associated metadata. When a user defines a device group, the engine validates the selected devices against the available inventory and ensures that the necessary device characteristics and test requirements are met. It then creates a logical association between the devices within the group.

Once the device groups are established, the device pooling/orchestration engine 205 manages the scheduling and execution of tests on these groups. It provides a mechanism for users to define how tests should be distributed among the devices in the pool. For example, users can specify whether a test should be run on a single device, any available device, or all devices within the group. The engine then coordinates with the test execution component of the system to dispatch the tests to the appropriate devices based on the defined scheduling rules.

The device pooling/orchestration engine 205 also handles the allocation and deallocation of devices during the testing process. It ensures that devices are properly reserved and released as tests are scheduled and completed. This helps optimize device utilization and prevents conflicts or inconsistencies in device usage.

Alternatively, the device pooling/orchestration engine 205 can be designed to support different approaches for device grouping and test scheduling. One alternative is to use a rule-based approach, where users define a set of rules or criteria for automatically grouping devices based on their characteristics. Another alternative is to employ machine learning techniques to automatically suggest optimal device groupings based on historical test data and device performance metrics. Additionally, the engine can be extended to support more advanced scheduling algorithms, such as load balancing or priority-based scheduling, to further optimize test execution across device groups.

In one embodiment, test results engine 206 is designed to manage test results for at least one test and/or at least one custom test device. This subsystem is capable of providing comprehensive details related to testing, including but not limited to at least one of test status, test results, test queue, test requirements, and test output. A key function of test results engine 206 is to offer an indication of a test outcome along with corresponding test criteria, which can be crucial for validating the readiness of a product for release.

The operation of test results engine 206 involves collecting and processing data generated from tests conducted on custom devices. This data is then analyzed to determine the outcome of each test, categorized based on predefined criteria such as pass, fail, or inconclusive. The engine can also manage a queue of tests, organizing them based on priorities, dependencies, and/or other relevant factors. Additionally, it keeps track of the specific requirements for each test, ensuring that all necessary conditions are met before execution.

Test results engine 206 works by interfacing with other components of the testing system, such as the job scheduler and/or the software agents on the devices. It receives data from these components, processes the data to extract meaningful insights, and then stores the results in an organized manner. This allows users to quickly access the information of interest, such as the status of ongoing tests, the outcomes of completed tests, and the overall progress towards meeting testing objectives.

Alternatives to test results engine 206 could include decentralized test result management systems, where results are managed locally on each device and then synchronized with a central repository. Another alternative could be the use of blockchain technology to create an immutable record of test results, enhancing security and traceability. Additionally, artificial intelligence and machine learning algorithms could be employed to analyze test results automatically, identifying patterns or anomalies that may not be immediately apparent to human testers. These alternatives could offer improvements in efficiency, security, and the depth of analysis possible with test results.

In one embodiment, the metrics and analytics engine 207 is a subsystem within the test automation system that processes and analyzes metrics associated with testing and lab operations. Its primary function is to collect, aggregate, and interpret data related to devices, hosts, and tests to provide meaningful insights and support data-driven decision-making.

At a high level, the metrics and analytics engine 207 receives raw data from different components of the test automation system, such as device logs, test results, and/or performance measurements. It then applies statistical and/or analytical techniques to transform this data into actionable information and/or visualizations.

The metrics and analytics engine 207 works by ingesting data from various sources and storing it in a structured format suitable for analysis. It may employ data processing pipelines to clean, normalize, and enrich the data as needed. The engine then applies predefined algorithms and/or queries to compute relevant metrics and/or generate reports.

One key aspect of the metrics and analytics engine 207 is its ability to summarize test results at different levels of granularity. It can provide an overview of test results across the entire system, highlighting at least one of the overall success rate, failure rate, and performance trends. Additionally, it can drill down to specific subsets of devices or tests, allowing users to analyze results based on at least one of device characteristics, test categories, and individual test cases.

The metrics and analytics engine 207 also enables trend analysis over time. It can track and/or visualize how test results and/or device performance evolve across multiple test runs and/or builds. This helps identify patterns, detect anomalies, and/or assess the impact of changes or optimizations made to the system or the devices under test.

To present the analyzed data effectively, the metrics and analytics engine 207 may generate various types of reports, dashboards, and/or visualizations. These can include at least one of summary tables, charts, graphs, and interactive tools that allow users to explore and/or slice the data based on different dimensions and filters.

Alternatively, the metrics and analytics engine 207 can be extended to support more advanced analytics capabilities. One alternative is to incorporate machine learning algorithms to automatically detect patterns, anomalies, and/or correlations in the data. Another alternative is to integrate with external business intelligence or data visualization tools, allowing users to create custom reports and dashboards tailored to their specific needs. Additionally, the engine can be designed to support real-time analytics, enabling users to monitor and/or respond to test results and device performance in near real-time.

In one embodiment, the device and host monitoring engine 209 is a subsystem within the test automation system that provides real-time status information and/or monitoring capabilities for custom test devices and host machines. Its primary function is to collect, process, and/or present data related to the health, availability, and/or utilization of these resources.

At a high level, the device and host monitoring engine 209 continuously gathers data from various sources, such as device agents, host agents, and/or system logs. It analyzes this data to determine the current state and performance of the devices and/or hosts involved in the testing process.

The device and host monitoring engine 209 works by deploying monitoring agents or probes on the target devices and hosts. These agents collect relevant metrics, such as CPU usage, memory consumption, network traffic, and/or device-specific parameters. The collected data is then transmitted to a central monitoring server, where it is processed and/or stored.

The engine employs various techniques to process and analyze the monitoring data. It may apply threshold-based rules to detect anomalies or deviations from expected behavior. For example, if a device's CPU usage exceeds a predefined threshold, the engine can flag it as a potential issue. Additionally, the engine may use statistical analysis and machine learning algorithms to identify patterns and trends in the data.

Based on the processed data, the device and host monitoring engine 209 provides a range of information to users. It can display the current status of devices, indicating whether they are online, offline, or in a specific state (e.g., idle, busy, or error). It also tracks device availability, showing which devices are currently available for testing and which ones are occupied or undergoing maintenance.

Furthermore, the engine can generate reports and/or visualizations on device utilization, highlighting how efficiently the devices are being used and potentially identifying any bottlenecks or underutilized resources. It may also provide insights into device health, such as identifying devices with high error rates or performance degradation over time.

The device and host monitoring engine 209 also includes an alerting and notification system. It can be configured to send alerts to users when certain events or conditions occur. For example, if all devices in a particular group go offline simultaneously, the engine can trigger an alert to notify the relevant stakeholders. Alerts can be delivered through various channels, such as email, SMS, or integration with incident management systems.

Alternatively, the device and host monitoring engine 209 can be extended to support more advanced monitoring and/or diagnostics capabilities. One alternative is to incorporate remote access and control functionality, allowing users to remotely troubleshoot and manage devices from a centralized console. Another alternative is to integrate with third-party monitoring and log aggregation tools, enabling a unified view of the entire testing infrastructure. Additionally, the engine can be designed to support custom monitoring plugins or extensions, allowing users to define their own monitoring metrics and rules specific to their testing requirements.

In one embodiment, the workflow engine 210 is a subsystem within the test automation system that orchestrates the scheduling and processing of tests based on predefined workflows. Its primary function is to execute tests in a specific sequence and apply scheduling logic to optimize test execution efficiency.

At a high level, the workflow engine 210 allows users to define and configure workflows that represent the desired sequence and scheduling of tests. These workflows can include multiple tests, each with its own dependencies, priorities, and execution requirements.

The workflow engine 210 works by interpreting the defined workflows and executing the tests accordingly. It analyzes the dependencies between tests and ensures that prerequisites are met before executing a particular test. The engine also applies the specified scheduling logic to determine the order and timing of test execution.

Users can interact with the workflow engine 210 to define the sequencing and scheduling of tests. They can specify the order in which tests should be executed, establishing dependencies and prerequisites as needed. Additionally, users can define scheduling logic, such as setting priorities, specifying time constraints, or defining parallel execution of independent tests.

The workflow engine 210 supports different scheduling methods to optimize test execution. It can execute tests sequentially, ensuring that each test is completed before moving on to the next one. Alternatively, it can leverage parallel execution, running independent tests concurrently to reduce overall execution time. The engine intelligently distributes tests across available resources, such as test devices or execution agents, to maximize parallelization.

Moreover, the workflow engine 210 allows users to define conditional and branching logic within workflows. This enables the creation of complex testing scenarios and automated testing pipelines. Users can specify conditions based on test results, device states, or external factors, and the engine will dynamically adjust the workflow execution based on these conditions. For example, if a particular test fails, the workflow can branch to a different set of tests or trigger specific actions, such as generating a bug report or notifying relevant stakeholders.

The workflow engine 210 provides a flexible and intuitive interface for users to define and manage workflows. It may offer a graphical workflow editor, allowing users to visually design workflows using drag-and-drop components and configurable properties. Additionally, it may support a domain-specific language (DSL) or scripting capabilities for more advanced workflow definitions.

Alternatively, the workflow engine 210 can be extended to support more advanced scheduling and orchestration features. One alternative is to integrate with external job scheduling systems, such as Apache Airflow or Jenkins, to leverage their capabilities for complex workflow management. Another alternative is to incorporate machine learning algorithms to automatically optimize workflow execution based on historical data and resource availability. Additionally, the engine can be designed to support distributed execution across multiple machines or cloud environments, enabling scalable and resilient test execution.

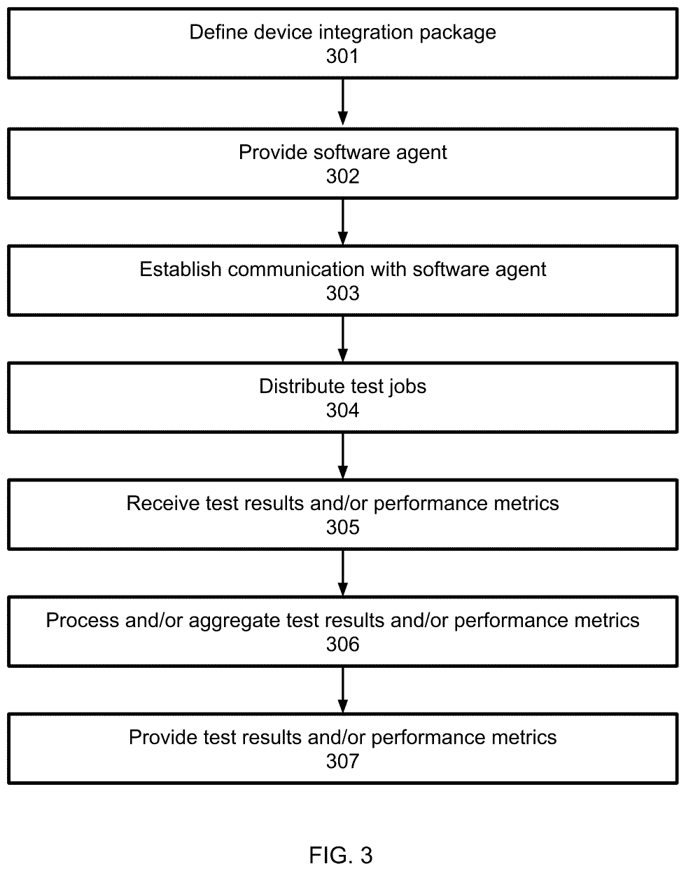

FIG. 3 illustrates an exemplary process for configuring a test lab and managing testing and results according to one embodiment of the invention. The process comprises defining a device integration package (DIP) 301, providing a cross-platform software agent 302, establishing communication between a backend system and the software agent 303, distributing test jobs across the plurality of devices using a job scheduler 304, receiving test results and/or performance metrics 305, processing and/or aggregating test results and/or performance metrics 306, and providing test results and/or performance metrics 307. The process steps described herein may be performed in association with a system such as that described in FIG. 1 and/or FIG. 2 above or in association with a different system. The process may comprise additional steps, fewer steps, and/or a different order of steps without departing from the scope of the invention as would be apparent to one of ordinary skill in the art.

In one embodiment, the device integration package (DIP) is a software component that enables seamless communication between the test automation system and a wide range of devices. The DIP serves as a bridge, facilitating the exchange of commands, data, and test results between the test automation system and the devices under test.

The DIP may comprise two main elements: a set of APIs and a configuration specification. The set of APIs defines a standardized technical interface that allows the test automation system to interact with the devices in a device-agnostic manner. These APIs are designed to be generic and compatible with various device types, ensuring that the test automation system can communicate with a diverse range of devices without requiring device-specific modifications.

The configuration specification provides a detailed description of how the test automation system should interact with each specific device using the set of APIs. It defines the mapping between the generic API calls and the device-specific commands and data formats. The configuration specification enables the test automation system to adapt its behavior based on the characteristics and capabilities of each device.

The set of APIs defined in the DIP includes several key functions. Firstly, it provides APIs for initiating communication between the test automation system and each device. These APIs establish a connection and perform any necessary handshaking or authentication procedures. Secondly, the DIP includes APIs for sending commands and data from the test automation system to the devices. These APIs allow the test automation system to control and configure the devices, trigger specific actions, and provide input data for testing purposes. Lastly, the DIP defines APIs for receiving data from the devices, including test results and performance metrics. These APIs enable the test automation system to collect and process the output generated by the devices during the testing process.

Alternatively, the DIP can be implemented using different approaches. One alternative is to use a plugin-based architecture, where device-specific plugins are developed to handle the communication and interaction with each device type. These plugins would adhere to a common interface defined by the DIP, allowing the test automation system to load and utilize them dynamically based on the devices being tested. Another alternative is to use a configuration-driven approach, where the behavior of the DIP is entirely determined by external configuration files. These configuration files would specify the mapping between the generic APIs and the device-specific commands, enabling the DIP to adapt to different devices without requiring code modifications.

In one embodiment, the process involves providing a cross-platform software agent 302. This software agent can be provided to each of the plurality of devices or to a host connected to each of the plurality of devices. The software agent is a versatile tool that can operate across a range of different operating systems, making it suitable for use in diverse testing environments.

The software agent 302 has several functions. It is operable to execute test jobs on each of the plurality of devices. This means that it can run a series of tests or tasks on each device, allowing for the evaluation of the device's performance or functionality. The software agent 302 is also capable of monitoring the status of each of the plurality of devices. This includes tracking the operational state of the device, such as whether it is online or offline, idle or active, and so on. Additionally, the software agent 302 can collect test results and performance metrics from each of the plurality of devices. This involves gathering data from the executed tests, which can then be analyzed to assess the device's performance.

The operation of the software agent 302 begins with its provision to each of the devices or to a host connected to each of the devices. Once the software agent 302 is installed and running, it can execute test jobs on the devices, monitor their status, and collect test results and performance metrics. The gathered data can then be transmitted back to a central location for further analysis.

In an alternative embodiment, the software agent 302 could be provided to a central server that communicates with each of the plurality of devices. This could allow for centralized control and coordination of the testing process. In another alternative, the software agent 302 could include additional features such as the ability to update device firmware, perform maintenance tasks, or manage device settings. These features could provide additional flexibility and control over the testing process.

In one embodiment, the software process involves establishing communication between a backend system and the software agent 303. This process is designed to facilitate interaction between the backend system and the agent installed on each of the plurality of devices. The communication is established using a set of APIs defined in the DIP, which provide a standardized interface for exchanging information.

The software process has several functions. Firstly, it establishes communication between the backend system and the software agent 303 on each device. This involves initiating a connection and exchanging initial data to confirm the successful establishment of communication. Secondly, the process can automatically discover and configure lab equipment connected to the plurality of devices. This involves scanning the network or device interfaces to identify connected lab equipment and then setting up this equipment for use in testing. Lastly, the process can control the lab equipment connected to the plurality of devices based on the test jobs being executed. This involves sending commands or instructions from the backend system to the lab equipment via the software agent 303.

The operation of the software process begins with the establishment of communication between the backend system and the software agent 303 using the APIs defined in the DIP. Once this communication is established, the process can discover and configure any connected lab equipment. This equipment can then be controlled based on the test jobs being executed, with commands or instructions sent from the backend system via the software agent 303.

In an alternative embodiment, the software process could involve establishing communication using a different set of APIs or a different communication protocol. In another alternative, the process could include additional steps such as verifying the compatibility of the lab equipment with the test jobs, or monitoring the status of the lab equipment during testing. These alternatives could provide additional flexibility or control over the testing process.

The process may comprise distributing test jobs across the plurality of devices using a job scheduler 304. The job scheduler may allocate and schedule tests based on predefined criteria, such as device availability, priority of tests, and specific requirements of each test job. This scheduling ensures that tests are performed efficiently and systematically across the available devices.

The job scheduler is operable to optimize allocation of the test jobs to the plurality of devices based on one or more technical criteria. The job scheduler may optimize allocation of the test jobs to the plurality of devices based on one or more of: hardware capabilities of each of the plurality of devices, software configurations of each of the plurality of devices, and network connectivity of each of the plurality of devices. The job scheduler may dynamically adjust allocation of the test jobs based on one or more of: real-time performance metrics of the plurality of devices, real-time status of the test jobs, and real-time availability of the plurality of devices.

The process may comprise receiving test results and/or performance metrics 305. Test results and/or performance metrics may be associated with at least one test and at least one custom test device. Test results and/or performance metrics may comprise comprehensive details related to testing, including but not limited to test status, test results, test queue, test requirements, and test output. Test results and/or performance metrics may provide an indication of a test outcome along with corresponding test criteria, which can be crucial for validating the readiness of a product for release.

Test results and/or performance metrics may be generated by collecting and processing data generated from tests conducted on custom devices. This data is then analyzed to determine the outcome of each test, categorized based on predefined criteria such as pass, fail, or inconclusive. Test results and/or performance metrics may be generated by interfacing with various components of the testing system, such as the job scheduler and the software agents on the devices. Test results and/or performance metrics may be generated by receiving data from components, processing the data to extract meaningful insights, and then storing the results in an organized manner.

The process may comprise processing and/or aggregating test results and/or performance metrics 306. Processing and/or aggregating test results and/or performance metrics may comprise receiving raw data from different components of the test automation system, such as device logs, test results, and performance measurements. In one aspect, statistical and/or analytical techniques may be used to transform this data into actionable information and visualizations. In one aspect, processing and/or aggregating may comprise ingesting data from various sources and storing it in a structured format suitable for analysis. Data processing pipelines to clean, normalize, and enrich the data may be employed as needed.

Processing and/or aggregating test results and/or performance metrics 306 may comprise summarize test results at different levels of granularity. It can provide an overview of test results across the entire system, highlighting the overall success rate, failure rate, and/or performance trends. Additionally, it can drill down to specific subsets of devices or tests, allowing users to analyze results based on device characteristics, test categories, or individual test cases. Processing and/or aggregating test results and/or performance metrics 306 may comprise analyzing the test results and performance metrics in real-time to detect anomalies and identify potential issues with the plurality of devices and/or the test jobs

Processing and/or aggregating test results and/or performance metrics 306 may comprise trend analysis. It can track and visualize how test results and device performance evolve across multiple test runs or builds. This helps identify patterns, detect anomalies, and assess the impact of changes or optimizations made to the system or the devices under test. Processing and/or aggregating test results and/or performance metrics 306 may comprise machine learning algorithms to automatically detect patterns, anomalies, or correlations in the data.

The process may comprise providing test results and/or performance metrics 307. Providing test results and/or performance metrics 307 may comprise generating interactive reports and visualizations based on the test results and performance metrics collected from the plurality of devices, the reports and visualizations being updated in real-time as new data is processed and aggregated by the backend system. This allows users to quickly access the information of interest, such as the status of ongoing tests, the outcomes of completed tests, and the overall progress towards meeting testing objectives. Providing test results and/or performance metrics may comprise generating various types of reports, dashboards, and visualizations. These can include summary tables, charts, graphs, and interactive tools that allow users to explore and slice the data based on different dimensions and filters.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

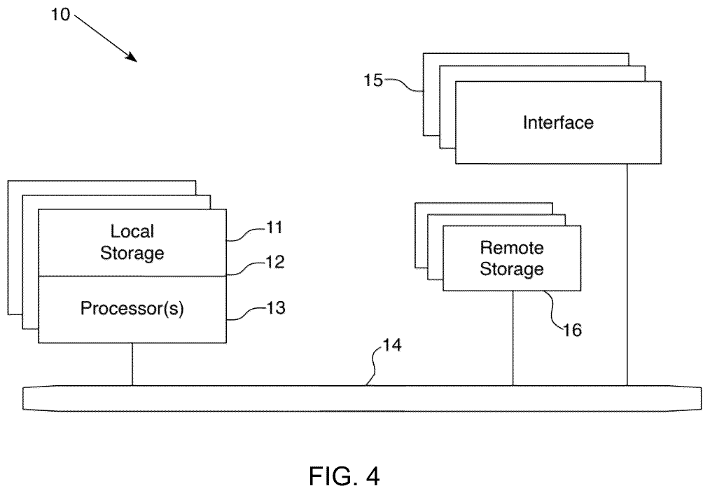

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above mentioned systems, units, modules, engines, controllers, components, process steps or the like may be and/or comprise hardware and/or software as described herein. For example, the systems, engines, and subcomponents described herein may be and/or comprise computing hardware and/or software as described herein in association with FIGS. 4-7. Furthermore, any of the above mentioned systems, units, modules, engines, controllers, components, interfaces or the like may use and/or comprise an application programming interface (API) for communicating with other systems units, modules, engines, controllers, components, interfaces or the like for obtaining and/or providing data or information.

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

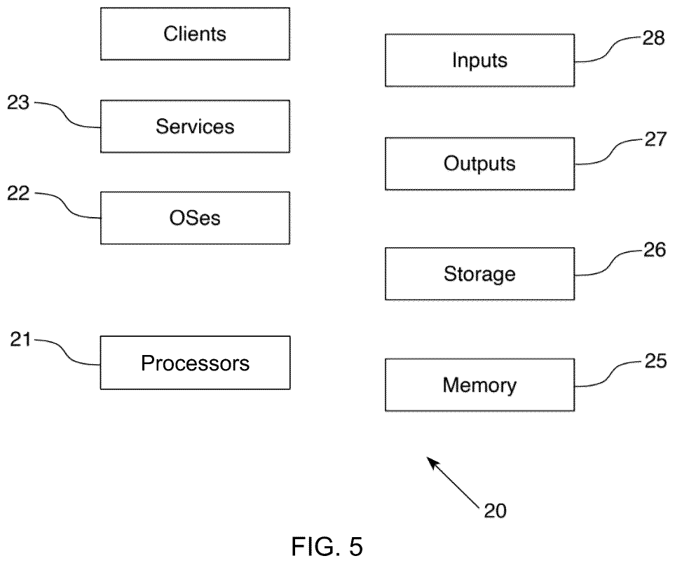

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

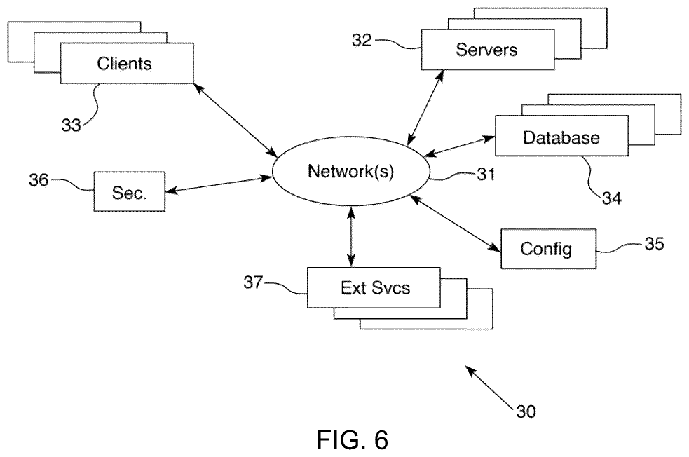

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

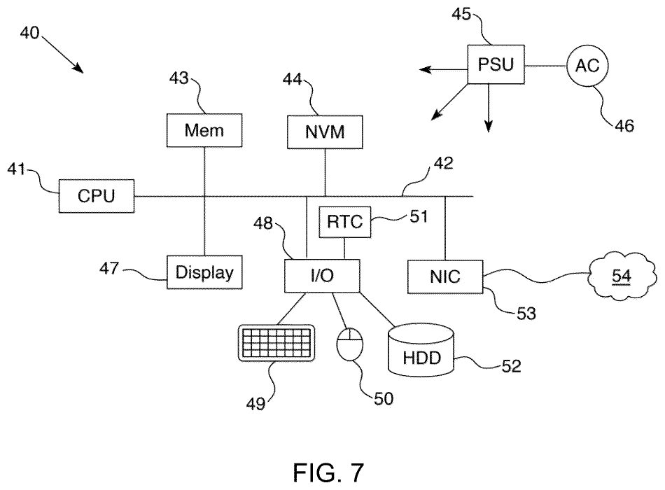

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computer implemented method for device testing and management, the computer implemented method comprising:
defining a device integration package (DIP) that enables communication between the test automation system and the plurality of devices, the DIP including:
a set of APIs that define a technical interface between the test automation system and the plurality of devices, the set of APIs being device-agnostic and configured to establish communication with the plurality of devices; and
a configuration specification that defines how the test automation system interacts with each of the plurality of devices using the set of APIs;
providing a cross-platform software agent to each of the plurality of devices or to a host connected to each of the plurality of devices;
establishing communication between a backend system and the plurality of devices using the DIP;
distributing test jobs across the plurality of devices using a job scheduler;
receiving, at the backend system, test results and/or performance metrics collected by the software agent;
processing and aggregating, at the backend system, the test results and/or performance metrics in real-time; and
providing, for display on a user device, the test results and/or performance metrics.

2. The computer implemented method according to claim 1, wherein the software agent is operable to:
execute test jobs on each of the plurality of devices;
monitor a status of each of the plurality of devices; and
collect test results and performance metrics from each of the plurality of devices.

3. The computer implemented method according to claim 1, wherein the job scheduler is operable to optimize allocation of the test jobs to the plurality of devices based on one or more technical criteria.

4. The computer implemented method according to claim 3, further comprising dynamically adjusting the allocation of the test jobs based on real-time monitoring of the status of the test jobs and the plurality of devices.

5. The computer implemented method according to claim 1, grouping the plurality of devices based on one or more technical criteria using device pooling techniques.

6. The computer implemented method according to claim 5, wherein the device pooling techniques comprise:
automatically discover and configure the plurality of devices; and
monitor the status and availability of the plurality of devices in real-time.

7. The computer implemented method according to claim 1, wherein the set of APIs defined in the DIP includes APIs for:
initiating communication between the test automation system and each of the plurality of devices;
sending commands and data from the test automation system to each of the plurality of devices; and
receiving data, including the test results and performance metrics, from each of the plurality of devices.

8. The computer implemented method according to claim 1, wherein the software agent is operable to be executed on a plurality of different operating systems.

9. The computer implemented method according to claim 1, wherein distributing test jobs across the plurality of devices using the job scheduler comprises optimizing allocation of the test jobs to the plurality of devices based on one or more of:
hardware capabilities of each of the plurality of devices;
software configurations of each of the plurality of devices; and
network connectivity of each of the plurality of devices.

10. The computer implemented method according to claim 1, wherein distributing test jobs across the plurality of devices using the job scheduler comprises dynamically adjusting allocation of the test jobs based on one or more of:
real-time performance metrics of the plurality of devices;
real-time status of the test jobs; and
real-time availability of the plurality of devices.

11. The computer implemented method according to claim 1, further comprising automatically discovering and configuring lab equipment connected to the plurality of devices; and controlling the lab equipment connected to the plurality of devices based on the test jobs being executed.

12. The computer implemented method according to claim 1, wherein providing the test results and/or performance metrics comprises generating interactive reports and visualizations based on the test results and performance metrics collected from the plurality of devices, the reports and visualizations being updated in real-time as new data is processed and aggregated by the backend system.

13. The computer implemented method according to claim 1, wherein processing and aggregating the test results and/or performance metrics comprises analyzing the test results and performance metrics in real-time to detect anomalies and identify potential issues with the plurality of devices and/or the test jobs.

14. The computer implemented method according to claim 1, wherein establishing communication comprises establishing communication between a backend system and the software agent via at least one of Message Queuing Telemetry Transport (MQTTS) protocol and HyperText Transfer Protocol (HTTP) protocol.

15. The computer implemented method according to claim 1, wherein establishing communication comprises establishing communication between the software agent and a target device via the DIP.

16. A computing system for device testing and management, the computing system comprising:
at least one computing processor; and
memory comprising instructions that, when executed by the at least one computing processor, enable the computing system to:
define a device integration package (DIP) that enables communication between the test automation system and the plurality of devices, the DIP including:
a set of APIs that define a technical interface between the test automation system and the plurality of devices, the set of APIs being device-agnostic and configured to establish communication with the plurality of devices; and
a configuration specification that defines how the test automation system interacts with each of the plurality of devices using the set of APIs;
provide a cross-platform software agent to each of the plurality of devices or to a host connected to each of the plurality of devices;
establish communication between a backend system and the plurality of devices using the DIP;
distribute test jobs across the plurality of devices using a job scheduler;
receive, at the backend system, test results and/or performance metrics collected by the software agent;
process and aggregate, at the backend system, the test results and/or performance metrics in real-time; and
provide, for display on a user device, the test results and/or performance metrics.

17. A non-transitory computer readable medium comprising instructions that when executed by a processor enable the processor to:
define a device integration package (DIP) that enables communication between the test automation system and the plurality of devices, the DIP including:
a set of APIs that define a technical interface between the test automation system and the plurality of devices, the set of APIs being device-agnostic and configured to establish communication with the plurality of devices; and
a configuration specification that defines how the test automation system interacts with each of the plurality of devices using the set of APIs;
provide a cross-platform software agent to each of the plurality of devices or to a host connected to each of the plurality of devices;
establish communication between a backend system and the plurality of devices using the DIP;
distribute test jobs across the plurality of devices using a job scheduler;
receive, at the backend system, test results and/or performance metrics collected by the software agent;
process and aggregate, at the backend system, the test results and/or performance metrics in real-time; and
provide, for display on a user device, the test results and/or performance metrics.
